(19) United States
(12) Patent Application Publication
(10) Pub. No.: US 2007/0215608 A1
(43) Pub. Date: Sep. 20, 2007

(54) Microwave Heating Method And Device Therefor

(75) Inventors: Koji Yoshino, Nara (JP); Tomotaka Nobue, Nara (JP); Ikuhiro Inada, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/568,263

(22) PCT Filed: Apr. 14, 2005
(86) PCT No.: PCT/JP05/07242

§ 371 Date: Oct. 25, 2006

(30) Foreign Application Priority Data
Apr. 28, 2004 (JP) 2004-132648

(51) Int. Cl. H05B 6/64

(52) U.S. Cl. 219/681

(57) ABSTRACT

The problem to be solved by the invention is to restrain local heating peculiar to microwave heating to thereby realize the uniform heating of an object to be heated and thus enhance the condition of the object to be heated after heated.

In a microwave heating method for supplying microwaves into a heating chamber 11 storing therein an object to be heated to heat the object to be heated, microwaves are supplied into the heating chamber 11 to heat the object to be heated; the temperature of the object to be heated is measured to check whether a given temperature difference has been generated in the temperature distribution of the object to be heated; and, when the given temperature difference has been generated, the minute particles of water are supplied into the heating chamber 11 to change the permittivity distribution state within the heating chamber 11, thereby changing the distribution of electric fields caused by the microwaves supplied into the heating chamber 11.

### TECHNICAL FIELD

The present invention relates to microwave heating method and apparatus for dielectrically heating an object to be heated.

### BACKGROUND ART

In a microwave oven which is a representative of a microwave heating apparatus, microwaves radiated from a magnetron are transmitted through a waveguide to a heating chamber to form standing waves within the heating chamber, and an object to be heated is caused to generate heat according to the electric field component of the standing waves and the dielectric loss of the object to be heated. Power P [W/m³], which is absorbed by the object to be heated per unit volume, can be expressed by the following equation: That is, P=(5/9) εr·tan δ·f·E²×10⁻¹⁰ [W/m³], where E[V/m] expresses the intensity of an electric field applied, f[Hz] expresses a frequency, εr expresses the relative permittivity (the real number portion of the permittivity) of the object to be heated and tan δ expresses the dielectric loss tangent of the object to be heated (here, δr·tan δ corresponds to the dielectric loss of the object to be heated).

Also, in the microwave oven, the size of the heating chamber for storing therein the object to be heated is generally as follows: that is, the width and depth dimensions thereof are respectively 30-40 cm, and the height dimension thereof is about 20 cm. On the other hand, the wavelength of a microwave used is about 12 cm and thus the microwave resonates within the heating chamber to thereby provide a standing wave, with the result that there are always generated high- and low-intensity electric field distributions; and further, the shape and physical properties of the object to be heated can cooperate together synergistically to thereby generate heat locally. Especially, when thawing a frozen food, in the area of the food where ice thaws and turns into water, the dielectric loss of such area increases suddenly and thus heating energy is concentrated onto such area, so that the temperature rising speed of such area becomes higher than its peripheral portions. In other words, while the heating of the icy portion of the object to be heated is slow, the heating of the thawed portion thereof is accelerated, with the result that there is a tendency to increase a difference in temperature between the icy and thawed portions. Thus, in the object to be heated, there occur local heating phenomena outstandingly, resulting in a problem that a partially-cooked portion and an unthawed portion coexist together.

As a method for restricting such local heating phenomena, there are known a so called turntable method in which the object to be heated is turned on a turntable to thereby vary the relative position of the object to be heated with respect to the electric field distribution, a so called stirrer method in which microwaves are stirred up to thereby vary the electric field distribution, a rotary antenna method, and the like. However, even with use of these methods, especially, when thawing a frozen food, there cannot be always obtained a satisfactory result but, depending on heating conditions, the temperature distribution increases, which results in the above-mentioned partially cooked phenomenon. In view of this, in the thawing treatment of the current microwave oven, by decreasing the output of the microwave intentionally or by setting the time not to apply the microwave during heating, the microwave oven is allowed to wait for realization of the averaged temperature due to the heat transfer in the interior of the food, thereby enhancing the cooked result of the food.

On the other hand, there is also known a method in which water particles are incorporated into a microwave heating apparatus and an object to be heated is heated by the water particles as well. For example, in the patent reference 1, there is disclosed a microwave heating apparatus which includes means for spraying water in a mist manner; and, in the patent reference 2, there is disclosed a microwave heating apparatus in which water stored in the water tank portion thereof is heated and boiled, and an object to be heated is heated and cooked by making use of steam generated from the heated and boiled water.

Patent Reference 1: Japanese Patent Publication Hei-6-272866

Patent Reference 2: Japanese Patent Publication Hei-8-296855

### DISCLOSURE OF THE INVENTION

### Problems that the Invention is to Solve

However, in the conventional cooking apparatus, since the object to be heated is humidified or heated by applying mist or steam to the object to be heated, for an object to be steamed such as a Chinese meat-bun and a shao-mai or for a food to be just warmed up or heated up, there may be obtained a good result, but, when a frozen food is thawed, there cannot be restricted the local heating phenomenon. Therefore, as for the thawing purpose, the conventional cooking apparatus cannot make the most of the advantage in supplying water particles.

The present invention is made to solve the problems found in the conventional cooking apparatus. And thus, it is an object of the invention to provide a microwave heating method and a microwave heating apparatus which can prevent the local heating phenomenon peculiar to the microwave heating to thereby be able to make uniform the heating of an object to be heated and thus enhance the cooked result of the object to be heated and, specifically, it is an object of the invention to provide microwave heating method and apparatus which, when thawing a frozen food, can enhance the cooked result of the food.

### MEANS FOR SOLVING THE PROBLEMS

The above object of the invention can be attained by the following articles.

(1) A microwave heating method for heating an object to be heated by supplying microwaves into a heating chamber storing therein the object, comprising the steps of: supplying microwaves into the heating chamber to heat the object to be heated; measuring the temperature of the object to be heated to check whether a given temperature difference has been generated in the temperature distribution of the object to be heated; and, when the given temperature difference has been generated, supplying the minute particles of water into the heating chamber to change the permittivity distribution condition within the heating chamber, thereby changing the distribution of electric fields due to the microwaves supplied into the heating chamber.

According to the present microwave heating method, when a given temperature difference has been generated, the minute particles of water are supplied into the heating chamber to change the permittivity distribution condition within the heating chamber, thereby changing the distribution of electric fields due to the microwaves supplied into the heating chamber. Thanks to this, the local heating peculiar to the microwave heating can be restricted, the heating of the object to be heated can be made uniform, and the heated result of the object to be heated can be enhanced.

(2) A microwave heating method as set forth in the article (1), further including the step of finely varying the electric field distribution due to the microwaves.

According to the present microwave heating method, since the electric field distribution is varied finely, the local heating can be restricted and thus the effect of heating the object to be heated uniformly can be enhanced.

(3) A microwave heating method as set forth in the article (1) or (2), wherein the minute particles of water are composed of steam supplied into the heating chamber.

According to the present microwave heating method, owing to use of steam as the minute particles of water, heat transfer by steam and the change of the permittivity of the interior of the heating chamber can be carried out at the same time, which can enhance the efficiency of the heating of the object to be heated.

(4) A microwave heating method as set forth in the article (1) or (2), wherein the minute particles of water are composed of mist-like water drops supplied into the heating chamber.

According to the present microwave heating method, owing to use of mist-like water drops as the minute particles of water, quick supply of water is possible, which can enhance the response of the electric field control.

(5) A microwave heating method for heating an object to be heated by supplying microwaves into a heating chamber storing therein the object, wherein, in a first state in which, of high- and low-intensity electric fields (antinodes and nodes) provided by supplying microwaves into the heating chamber, the high-intensity electric fields (antinodes) are present two or more in number within the heating chamber, the object to be heated is microwave heated; and, after then, in a second state in which the minute particles of water are supplied into the heating chamber to change the permittivity distribution state of the interior of the heating chamber to thereby increase the number of the high-intensity electric fields over the first state, the object to be heated is microwave heated.

According to the present microwave heating method, after the object to be heated is microwave heated in a first state in which two or more high-intensity electric fields are present within the heating chamber, the minute particles of water are supplied into the heating chamber to change the permittivity distribution state of the interior of the heating chamber to thereby increase the number of the high-intensity electric fields over the first state. Thanks to this, the high-intensity electric fields can be generated not partially only in the specific positions of the object to be heated but uniformly over the entire areas thereof, thereby being able to enhance the uniform heating of the object to be heated.

(6) A microwave heating method as set forth in the article (5), wherein switching from the first state to the second state is executed when the temperature of the object to be heated is measured and a given temperature difference is generated in the temperature distribution of the object to be heated.

According to the present microwave heating method, since the state of the electric fields is changed when a given temperature difference is generated in the temperature distribution of the object to be heated, the temperature difference can be reduced and thus the temperature distribution can be made uniform.

(7) A microwave heating apparatus for heating an object to be heated by supplying microwaves into a heating chamber storing therein the object, comprising: a microwave generating part for supplying microwaves to the heating chamber; temperature measuring means for measuring the temperature distribution of the interior of the heating chamber; permittivity changing means, by supplying the minute particles of water into the heating chamber, for changing the permittivity distribution state of the interior of the heating chamber; and, heating control means for controlling the permittivity changing means based on a microwave heating method as set forth in any one of the above-mentioned articles (1)-(6).

According to the present microwave heating apparatus, while supplying microwaves from the microwave generating part to the heating chamber, the temperature distribution of the interior of the heating chamber is measured using the temperature measuring means and the minute particles of water are supplied into the heating chamber at a given timing, thereby changing the distribution of electric fields provided by the microwaves supplied into the heating chamber. Thanks to this, the local heating peculiar to the microwave heating can be restricted, the uniform heating of the object to be heated can be realized, and the cooked state of the object to be heated after heated can be enhanced.

(8) A microwave heating apparatus as set forth in the article (7), wherein the permittivity changing means includes a water tank, an evaporation dish disposed within the heating chamber, a water pump for supplying a given amount of water from the water tank to the evaporation dish, and evaporation dish heating means for heating the evaporation dish to generate steam from the evaporation dish.

According to the present microwave heating apparatus, by supplying a given amount of water from the water tank to the evaporation dish using the water pump and heating the evaporation dish using the evaporation dish heating means, a desired amount of steam can be generated. Also, since the evaporation dish is disposed within the heating chamber, it is easy to clean the heating chamber and thus the interior of the heating chamber can be kept sanitary.

(9) A microwave heating apparatus as set forth in the article (7), wherein the permittivity changing means includes mist supply means for supplying mist-like water drops into the heating chamber.

According to the present microwave heating apparatus, since mist-like water drops can be supplied in one go from the mist supply means into the heating chamber, the distribution of the high-intensity electric fields can be changed quickly.

(10) A microwave heating apparatus for heating an object to be heated by supplying microwaves into a heating chamber storing therein the object, comprising: a microwave generating part for supplying microwaves to the heating chamber; a water tank; an evaporation dish disposed within the heating chamber; water supply means for supplying a given amount of water from the water tank to the evaporation dish; and evaporation dish heating means for heating the evaporation dish to generate steam, wherein the microwave heating apparatus further includes: permittivity changing means having a first permittivity distribution state for heating the evaporation dish after supply of the water to the evaporation dish to thereby generate steam and a second permittivity distribution state for supplying the water after heating of the evaporation dish to thereby generate steam immediately; and, heating control means for controlling the permittivity changing means.

According to the present microwave heating apparatus, using the permittivity changing means, there are respectively generated the first permittivity distribution state for heating the evaporation dish after supply of the water to the evaporation dish to thereby generate steam as well as the second permittivity distribution state for supplying the water after heating of the evaporation dish to thereby generate steam immediately, and these first and second states are controlled using the heating control means, whereby the electric field distribution state of the interior of the heating chamber can be changed and thus the object to be heated can be heated uniformly.

### EFFECTS OF THE INVENTION

According to the microwave heating method and apparatus of the invention, the minute particles of water are supplied into the heating chamber to change the permittivity distribution state of the interior of the heating chamber, thereby changing the electric field distribution of the interior of the heating chamber provided by microwaves supplied into the heating chamber. Thanks to this, the local heating peculiar to the microwave heating can be restrained and thus the heating of the object to be heated can be made uniform, resulting in the enhanced finished state of the object to be heated after heated.

### BRIEF DESCRIPTION OF THE DRAWINGS

FIG. 1 is a front view of a microwave heating apparatus according to the invention, showing a state in which an opening and shutting door is opened.

FIG. 2 is an explanatory view of the basic operation of the microwave heating apparatus.

FIG. 3 is an explanatory view of a water supply passage to a steam supply part.

FIG. 4 is a block diagram of a control system for controlling a microwave heating apparatus.

FIG. 5 is a plan view of a heating chamber, when the bottom surface thereof is viewed from above.

FIG. 6 is an explanatory view of a high-intensity electric field mode shown in FIG. 5, while the mode is expressed in a simplified or three-dimensional manner where r=2, s=2 and t=3.

FIGS. 7A to 7D are explanatory views of the variations of high-intensity electric fields occurring on the wall surface of a heating chamber.

FIGS. 8A and 8B are explanatory views of the conceptual states of microwaves, FIG. 8A showing a state where the minute particles of water are not supplied to the heating chamber and FIG. 8B showing a state where the minute particles of water are supplied.

FIGS. 9A and 9B are time charts of an example of the sequence of the microwave heating and steam supply in the thawing treatment of a frozen food.

FIGS. 10A and 10B explain the measurement of the temperature of an object to be heated made by an infrared sensor, specifically, FIG. 10A shows the state of scanning, while FIG. 10B shows data obtained by the scanning.

FIG. 11 is a graphical representation of a temperature distribution in the L line position shown in FIG. 10B when scans are carried out several times consecutively by an infrared sensor.

FIG. 12 is a graphical representation of temperature variations when two objects to be heated M1 and M2 having different weights are heated at the same initial temperature under the same condition.

FIG. 13 is a graphical representation of variations in the relative permittivity of the interior of a heating chamber after start of steam supply.

FIGS. 14A to 14C are explanatory views of the conceptual heated state of an object to be heated.

FIG. 15 is a view of a result obtained when the electric field strength distribution within a microwave space is CAE analyzed where the permittivity of the interior of a heating chamber is set for 1 which is equivalent to the air.

FIG. 16 is a view of a result obtained when the electric field strength distribution within a microwave space is CAE analyzed where the permittivity of the whole of a heating chamber is set for 3 which is equivalent to steam.

FIGS. 17A and 17B are diagrams of an equal electric field intensity in the interior of an object to be heated obtained by a CAE analysis, specifically, FIG. 17A shows a case when the permittivity of the interior of a heating chamber is set for 1 which is equivalent to the air, and FIG. 17B shows a case when the permittivity of the whole of a heating chamber is set fore 3 which is equivalent to steam.

FIGS. 18A and 18B are explanatory views of the heating patterns of an object to be heated, specifically, FIG. 18A shows the time when the microwave heating of the object to be heated is started with no supply of steam, and FIG. 18B shows the state of the heating after steam is supplied.

FIGS. 19A and 19B are explanatory views of the high-intensity electric fields in the interior of an object to be heated in the form of models, specifically, FIG. 19A shows the distribution of the high-intensity electric fields when the object to be heated is heated using microwaves, and FIG. 19B shows a case when the object to be heated is heated with supply of steam.

FIG. 20 is an explanatory view of the examples of the positions of the high-intensity electric fields in first and second states.

FIG. 21 is a schematic structure view of a microwave heating apparatus according to a second embodiment of the invention.

FIG. 22 is a schematic structure view of a microwave heating apparatus according to a third embodiment of the invention.

### DESCRIPTION OF REFERENCE NUMERALS AND SIGNS

10: Main body case
11: Heating chamber
11A: Upper section space
12: Microwave generating portion
13: Magnetron
14: Hot wind generating portion
15: Steam supply part
17: Circulation fan
18: Infrared sensor
19: Convection heater
20: Thermistor
33: Stirrer blade
35: Evaporation dish
35a: Pool recessed portion
37: Evaporation dish heating heater
38: Water tank
39: Water pump
51: Control part
53: Input operation part
55: Display panel
61: Ferromagnetic field
63, 65: Ferromagnetic field
67, 69, 71, 73: High-intensity electric field
87: Mist supply means
100, 200, 300: Microwave heating apparatus
M: Object to be heated
S: Steam
ε: Permittivity
εr: Relative permittivity
λ: Wavelength

### BEST MODE FOR CARRYING OUT THE INVENTION

Now, description will be given below in detail of preferred embodiments of a microwave heating method and a microwave heating apparatus according to the invention with reference to the accompanying drawings.

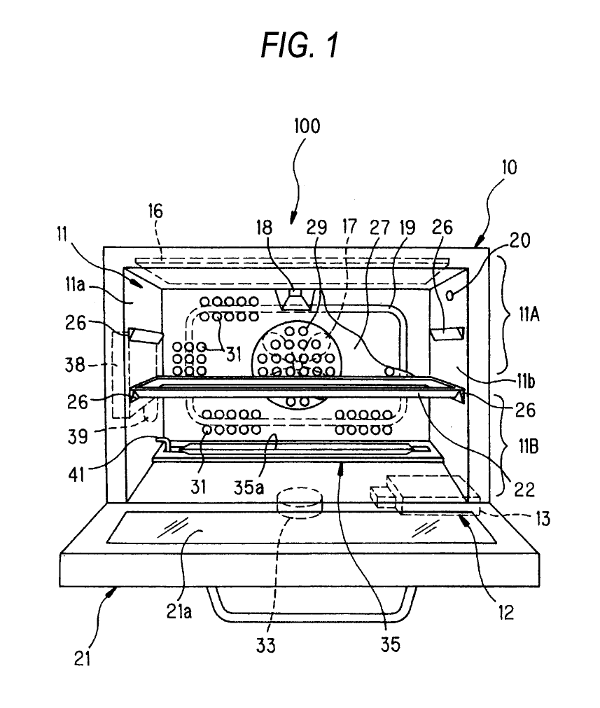

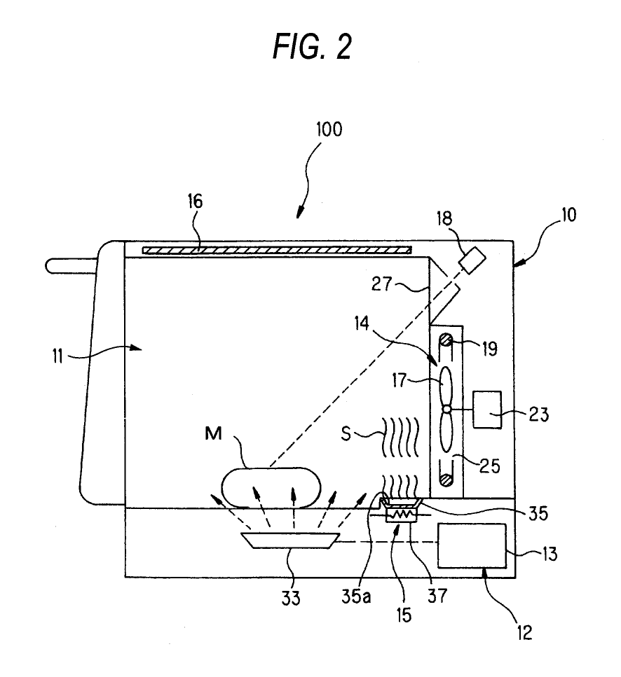

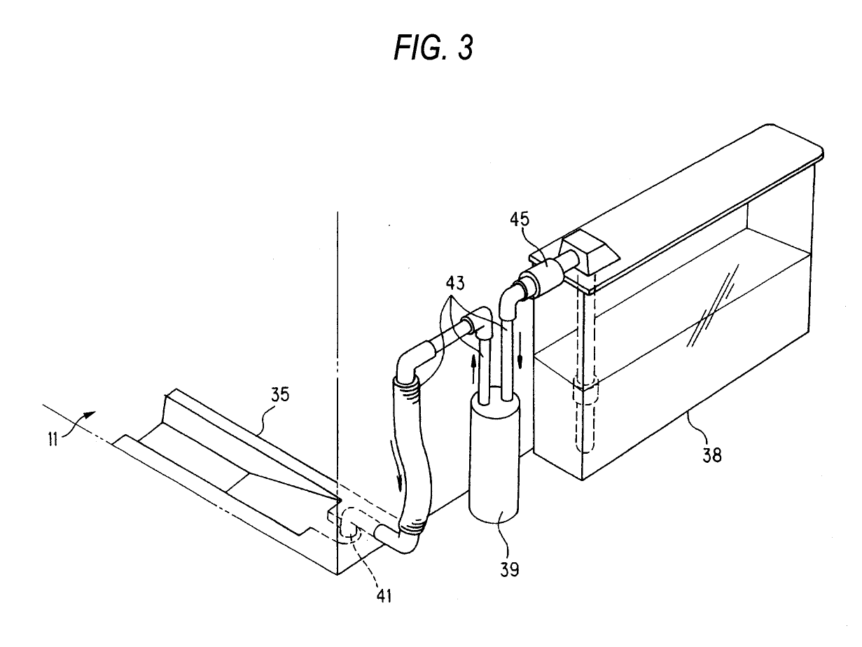

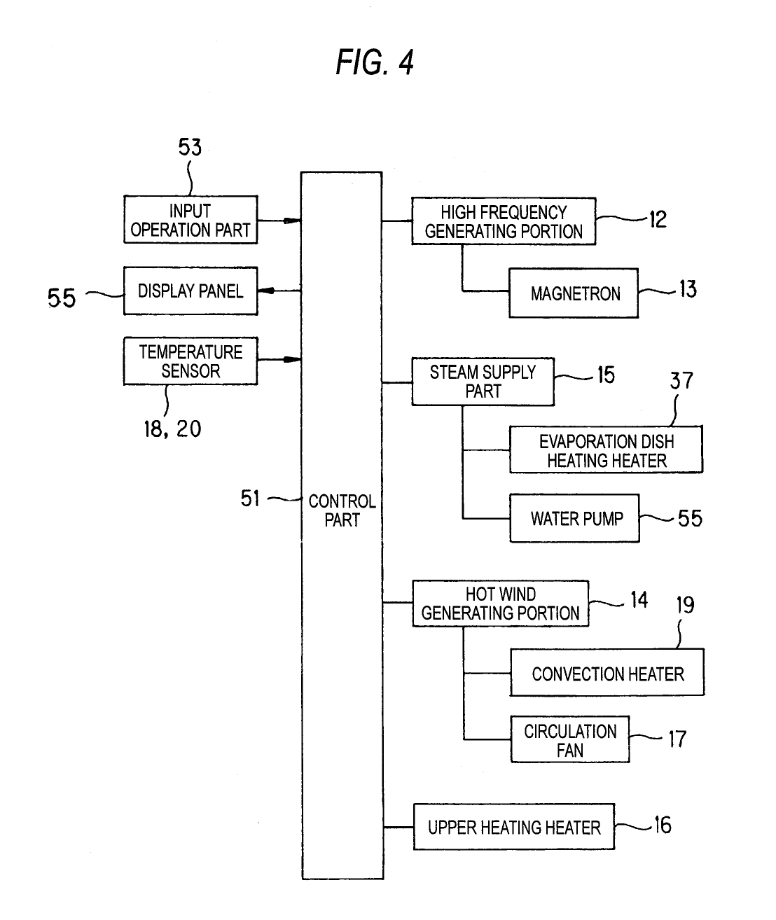

FIG. 1 is a front view of a microwave heating apparatus according to the invention, showing a state in which an opening and shutting door is opened, FIG. 2 is an explanatory view of the basic operation of the microwave heating apparatus, FIG. 3 is an explanatory view of a water supply passage to a steam supply part, and FIG. 4 is a block diagram of a control system for controlling the microwave heating apparatus.

This microwave heating apparatus (which is hereinafter referred to as a cooking apparatus) 100 is a cooking apparatus which, as shown in FIG. 1, supplies at least one of microwaves and steam S to a heating chamber 11 storing therein an object to be heated to heat treat the object to be heated. The cooking apparatus 100 comprises a magnetron 13 serving as a microwave generating portion 12 for generating microwaves, a steam supply part 15 which generates steam S within the heating chamber 11 and functions as permittivity changing means, an upper heating heater 16 disposed upwardly of the heating chamber 11, a circulation fan 17 for stirring up and circulating the air existing within the heating chamber 11, and a convection heater 19 for heating the air circulating within the heating chamber 11. Also, the cooking apparatus 100 further includes an infrared sensor 18 functioning as temperature measuring means for measuring the temperature of the object to be heated within the heating chamber 11 through a detecting hole formed in the wall surface of the heating chamber 11, a thermistor 20 disposed on the wall surface of the heating chamber 11 for measuring the temperature of the heating chamber 11, and a tray 22 functioning as a partition plate removably disposed upwardly of the bottom surface of the heating chamber 11 with a given clearance between them for dividing the heating chamber 11 vertically into upper and lower section spaces.

As shown in FIGS. 1 and 2, the heating chamber 11 is formed in the interior of a box-shaped main body case 10 with its front surface opened. On the front surface of the main body case 10, there is mounted an opening and shutting door 21 with a transparent window 21a for opening and closing the object-to-be-heated take-out mouth of the heating chamber 11. The lower end of the opening and shutting door 21 is hinge connected to the lower edge of the main body case 10, whereby the opening and shutting door 21 can be opened and shut in the vertical direction.

The magnetron 13 is disposed, for example, in the lower section space of the heating chamber 11 and, at a position where microwaves generated from the magnetron 13 are received, there is provided a stirrer blade 33 (or a rotary antenna or the like) serving as radio wave stirring means. And, by radiating the microwaves from the magnetron 13 onto the rotating stirrer blade 33, the microwaves can be supplied into the heating chamber 11 by the stirrer blade 33 while the microwaves are being stirred up by the stirrer blade 33. By the way, the mounting portions of the magnetron 13 and stirrer blade 33 are not limited to the bottom portion of the heating chamber 11, but they may also be mounted on the upper surface or side surfaces of the heating chamber 11.

As shown in FIG. 2, in the deep side space of the heating chamber 11, there is disposed a circulation fan chamber 25 in which there are stored the circulation fan 17 and its drive motor 23; and, the rear wall surface of the heating chamber 11 provides a deep side wall surface 27 which separates the heating chamber 11 and circulation fan chamber 25 from each other. In the deep side wall surface 27, there are formed air intake ventilation holes 29 for sucking the air from the heating chamber 11 side to the circulation fan chamber 25 side, and air feed ventilation holes 31 for supplying the air from the circulation fan chamber 25 side to the heating chamber 11 side, while the respective formation areas of the air intake ventilation holes 29 and the air feed ventilation holes 31 are separated from each other (see FIG. 1). The respective ventilation holes 29 and 31 are formed in the form of a large number of punched holes.

A hot wind generating portion 14 is composed of the circulation fan 17 and convection heater 19. Within the circulation fan chamber 25, there is provided the rectangular-ring-shaped convection heater 19 in such a manner that it surrounds the circulation fan 17. And, the air intake ventilation holes 29 are arranged in front of the circulation fan 17, while the air feed ventilation holes 31 are arranged at positions along the rectangular-ring-shaped convection heater 19. Therefore, when the circulation fan 17 is driven and rotated, the air existing in the interior of the heating chamber 11 is sucked through the air intake ventilation holes 29 into the central position of the convection heater 19 where the circulation fan 17 exists and is diffused radially there; and the air passes through the neighborhood of the convection heater 19 and is thereby heated, and is then charged through the air feed ventilation holes 31 into the heating chamber 11. That is, the air provides a circulation wind.

Also, the steam supply part 15 comprises an evaporation dish 35 including a pool recessed portion 35a for generating steam S by heating, and an evaporation dish heating heater 37 disposed downwardly of the evaporation dish 35 for heating the evaporation dish 35. The evaporation dish 35 is composed of, for example, a stainless-steel made plate member which includes a recessed portion and has a narrow and long shape. The evaporation dish 35 is disposed on the deep side bottom surface of the heating chamber 11 on the opposite side of the object-to-be-heated take-out mouth, while the longitudinal direction of the evaporation dish 35 extends along the deep side wall surface 27. By the way, as the evaporation dish heating heater 37, although not shown, there is employed a heater having a structure in which an aluminum die cast heat block with a heat generating element such as a sheath heater is in contact with the evaporation dish 35. Alternatively, the evaporation dish 35 may be heated with radiant heat using a glass tube heater or a sheath heater. Or, there may also be employed a structure in which a plate heater or the like is bonded to the evaporation dish 35.

Also, as shown in FIGS. 1 and 3, within the main body case 10, there are disposed a water tank 38 for storing therein water which is to be supplied to the evaporation dish 35, a water pump 39 for feeding the water stored in the water tank 38, and a water supply pipe line 43 the discharge port 41 of which is disposed opposed to the evaporation dish 35. Water, which is stored in the water tank 38, as the need arises, can be supplied by a desired amount through the water supply pipe line 43 to the evaporation dish 35. By the way, in order that the cooking apparatus 100 can be prevented from increasing in size when the water tank 38 is incorporated into the cooking apparatus 100, the water tank 38 is buried in a compact manner into the side wall portion of the main body case 10 that is relatively hard to become high in temperature.

The upper heating heater 16 is a plate heater such as a mica heater which applies heat for grill cooking or preheats the heating chamber 11; and, the upper heating heater 16 is disposed upwardly of the heating chamber 11. Also, the upper heating heater 16 may also be composed of a sheath heater instead of the plate heater.

The thermistor 20 is disposed on the wall surface of the heating chamber 11 and is used to detect the temperature of the interior of the heating chamber 11. On the wall surface of the heating chamber 11, there is further provided the infrared sensor 18 in a freely oscillatable manner which can measure the temperatures of two or more points (for example, 8 points) at the same time. Using a scanning operation which can be carried out by oscillating the infrared sensor 18, the temperatures of two or more measuring points within the heating chamber 11 can be measured and further, to monitor the temperatures of the measuring points with the passage of time can tell the position of placement of the object to be heated M.

The tray 22 is removably supported on securing portions 26 which are respectively provided on the side surfaces 11a and 11b of the heating chamber 11. The securing portions 26 are arranged in two or more stages in such a manner that they can support the tray 22 at two or more height positions. By securing the tray 22 to the securing portions 26, the heating chamber 11 can be divided into an upper section space 11A and a lower section space 11B.

Now, FIG. 4 is a block diagram of a control system employed in the cooking apparatus 100 and this control system is mainly composed of a control part 51 including, for example, a microprocessor. The control part 51 mainly transmits and receives signals with respect to an input operation part 53, a display panel 55, the microwave generating portion 12, the steam supply part 15, the hot wind generating portion 14, the upper heating heater 16, temperature sensors 18, 20 and the like; and, the control part 51 controls these respective portions.

The input operation part 53 includes various kinds of keys such as a start key, a switching key for switching heating methods, and an automatic cooking key; and, cooking is carried out by operating the keys properly according to the heating contents while confirming the temperatures displayed on the display panel 55.

Next, description will be given below of the basic operation of the cooking apparatus 100.

As shown in FIG. 2, firstly, a food, which is the object to be heated M, is put on a dish or the like and is inserted into the heating chamber 11, and, after then, the opening and shutting door 21 is shut. By operating the input operation part 53, a cooking method, a heating time, a heating temperature and the like are set and, after then, when a start button is depressed, the cooking is carried out automatically according to the operation of the control part 51.

For example, when a mode “steam generation+circulation fan ON” is selected, since the evaporation dish heating heater 37 is switched on, water in the evaporation dish 35 is heated to thereby generate the steam S. Since the steam S rising from the evaporation dish 35 is allowed to circulate through the heating chamber 11, the steam S can be uniformly blown onto the object to be heated M.

In this case, since the steam S within the heating chamber 11 can be heated by switching on the convection heater 19, the temperature of the steam S circulating through the heating chamber 11 can be set at a further higher temperature. Therefore, there can be obtained so called overheated steam, which makes it possible to cook the object to be heated M in such a manner that it has a browned surface. Also, when executing the microwave heating, the magnetron 13 may be turned on to rotate the stirrer blade 33, so that the microwaves can be supplied into the heating chamber 11 while they are being stirred up uniformly, thereby being able to microwave cook the object to be heated M evenly.

As described above, according to the cooking apparatus 100, by using the magnetron 13, hot wind generating portion 14, steam supply part 15 and upper heating heater 16 independently or in combination, the object to be heated (food) M can be heated according to the heating method that is best for cooking.

By the way, the temperature of the interior of the heating chamber 11 in the above-mentioned cooking time is measured by the infrared sensor 18 or thermistor 20 and, based on this measurement result, the control part 51 controls the magnetron 13, upper heating heater 16, convection heater 19 and the like properly.

In addition to the above-mentioned basic control of the composing parts, the cooking apparatus 100 according to the invention further has a function to control cooking using microwaves.

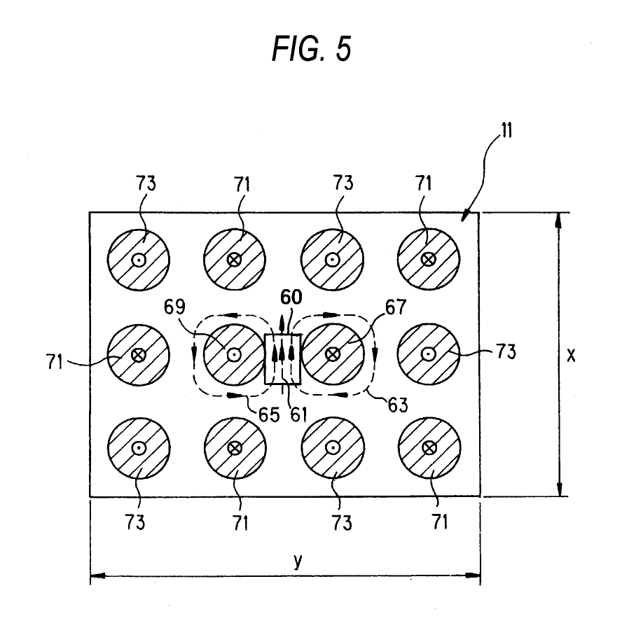

FIG. 5 is a plan view of the bottom surface of the heating chamber when it is viewed from above.

For simplification of description, assuming that, instead of the stirrer blade, in the central portion of the bottom surface of the heating chamber 11, there exists a radio wave opening 60 for supplying microwaves, in the vicinity of the radio wave opening 60, ferromagnetic fields 63, 65 (which are designated by broken-line arrow marks respectively) in the same direction are easy to occur due to ferromagnetic fields 61 (which are shown by broken-line arrow marks). Owing to this, when the microwaves enter the heating chamber 11, the microwaves resonate with the ferromagnetic fields within the heating chamber 11. In the resonating state, differently from the transfer state within a waveguide, a magnetic field and an electric field are 90 degrees out of phase with each other, whereby there are generated high-intensity electric fields 67, 69 (which are shown by solid-line arrow marks) which are out of phase with the ferromagnetic fields 63, 65 in such a manner that they hold the radio wave opening 60 between them.

The resonating state, when the object to be heated is absent, is decided by the shape of the heating chamber and the position of the radio wave opening. According to the present embodiment, it is assumed that the high-intensity electric fields 67, 69 out of phase with the ferromagnetic fields 63, 65 stand perpendicularly to the bottom surface of the heating chamber 11 and, at the same time, high-intensity electric fields 71 stand in the same direction (in FIG. 5, in the far side direction) as the high-intensity electric field 67 and high-intensity electric fields 73 stand in the same direction (in FIG. 5, in the near side direction) as the high-intensity electric field 69. Of course, the directions of the respective high-intensity electric fields are reversed at the speed of 2.45 GHz. Here, slanting line portions in FIG. 5 express areas where, of the electric fields that are generated on the bottom surface of the heating chamber 11, the electric fields the intensity of which is higher than a certain level exist; and, there are generated three high-intensity electric fields in the deep side direction (x direction) of the heating chamber, and four high-intensity electric fields in the width direction thereof (y direction). The reason for this is that, owing to the generation of the resonating state, electromagnetic waves are distributed as standing waves within the heating chamber to thereby cause the antinodes of the electric fields; and, the number of these antinodes is called a mode. Normally, where the shape of the heating chamber is expressed by three dimensions and the dimensions of the respective directions are expressed as w, y and z, if the antinodes of the electric fields are present by r, and t in number in the respective directions, then the mode is expressed as (r s t). In the example shown in FIG. 5, r=3 and s=4.

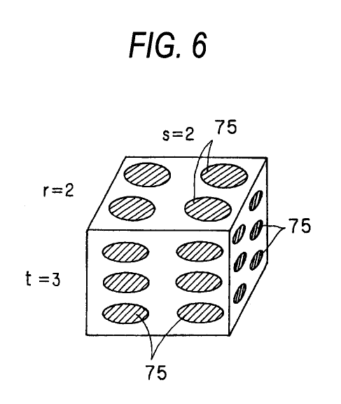

Now, FIG. 6 is a three-dimensional representation of a simplified version of the mode of the high-intensity electric fields shown in FIG. 5, where r=2, S=2 and t=3. Slanting line portions in FIG. 6 express areas where, of the electric fields that are generated on the wall surfaces of the heating chamber 11, there exist the electric fields the intensity of which is higher than a given level, while the mutually facing wall surfaces of the heating chamber show electric field distributions which are symmetric. When the number of the high-intensity electric fields 75 (the antinodes of the electric fields) shown by the slanting line portions is counted, there stand two high-intensity electric fields 75 (r=2) in the x direction, two (s=2) in the y direction, and three (t=3) in the z direction, which shows a mode (223).

Here, in a state where the object to be heated is not present within the heating chamber 11, when the heating chamber 11 is a cuboid, according to the dimensions of the heating chamber 11 and the position of the radio wave opening, a standable mode can be found analytically. Where the dimensions of the heating chamber 11 are x, y and z, the number of modes standing in the respective directions is the number of combinations of r, s and t which satisfy the following equation (1). (Here, x, y and z are expressed in a unit of mm; r, s and t are integers; and λ is the wavelength of a microwave and it is about 122 mm).
1/λ²=(r/(2x))²+(s/(2y))²+(t/(2z))² (1)

On the other hand, when the object to be heated is present within the heating chamber 11, the number of modes deviates from the equation (1) due to the influence of the compression of the wavelength caused by the permittivity of the object to be heated. However, experiments have shown that, even when the object to be heated is present within the heating chamber 11, in the vicinity of the radio wave opening, modes satisfying the equation (1) are ready to stand, but at positions distant from the radio wave opening, modes are often disturbed. Therefore, when the dimensions of the heating chamber 11 are decided in such a manner that a desired mode can be obtained according to the equation (1) with the wavelength λ=122 mm, there can be generated a substantially arbitrary mode. Also, when the stirrer blade 33 is used, since it is considered that the position of the radio wave opening 60 is varied continuously due to the rotational movement of the stirrer blade 33, a mode can be changed to some degrees.

Further, by varying the wavelength λ of the microwave, the mode can be changed. Specifically, by supplying the minute particles of water, which are dielectric substances, into the heating chamber 11, the wavelength of the microwave can be changed. Now, where the wavelength after changed is expressed as λa and the permittivity of the interior of the heating chamber 11 is expressed as ε, the wavelength after changed λa can be expressed by the following equation (2).
λa=λ/√ε (2)

The permittivity ε provides 1 for the air and about 3 for steam. That is, by supplying steam from the steam supply part 15 into the heating chamber 11, the permittivity of the interior of the heating chamber 11 is changed, whereby the wavelength of the microwave is shifted to the short wavelength side according to the relation of the equation (2). As a result of this, the mode of the high-intensity electric fields to be decided according to the equation (1) is changed.

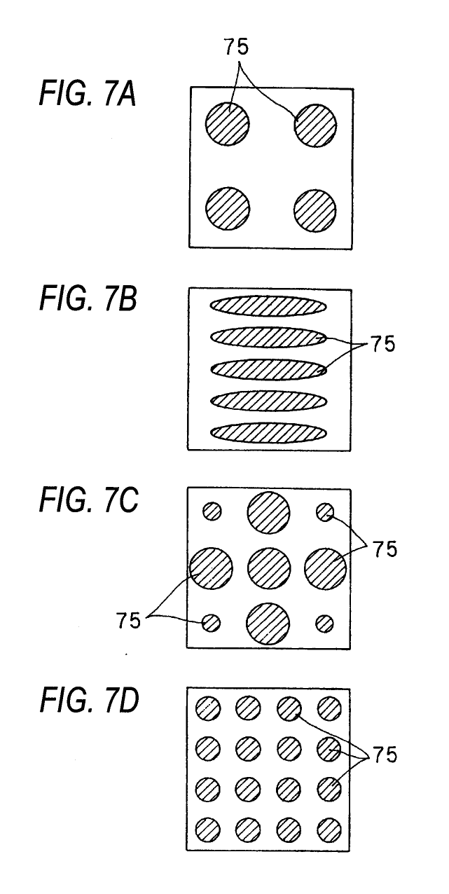

Now, FIG. 7 is a view of the variations of the high intensity electric fields occurring on the wall surfaces of the heating chamber. Assuming that the high-intensity electric fields 75 shown in FIG. 7 are present at the positions of the high-intensity electric fields on the bottom surface of the heating chamber, FIG. 7A shows a mode in which r=2 and s=2; and, this shows the same state as the state of the high-intensity electric fields shown in FIG. 6. When the water minute particles are supplied into the heating chamber 11 from the state shown in FIG. 7A, the state is shifted to other states, for example, as shown in FIGS. 7B, 7C and 7D. FIG. 7B shows a mode in which r=5 and s=1; FIG. 7C shows a mode in which r=3 and s=3; and, FIG. 7D shows a mode in which r=4 and s=4. That is, the state of the high-intensity electric fields varies in this manner.

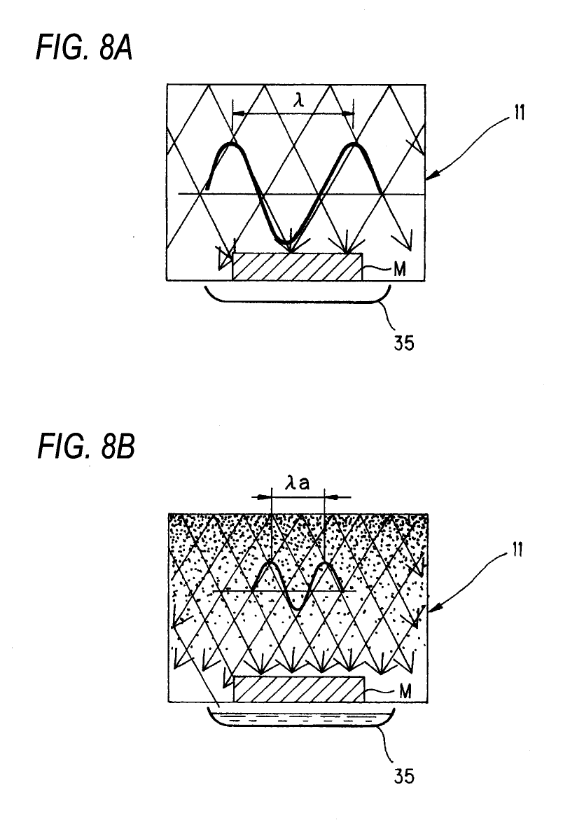

Now, FIG. 8 is an explanatory view to explain conceptually the states of a microwave respectively in a case shown in FIG. 8A when the water minute particles are not supplied into the heating chamber 11 and in a case shown in FIG. 8B when the water minute particles are supplied.

In the case shown in FIG. 8A where the water minute particles are not supplied, the microwave heating is carried out while the wavelength of the microwave is about 122 mm. On the other hand, in the case shown in FIG. 8B where the water minute particles are supplied, the permittivity of the interior of the heating chamber 11 increases and thus the wavelength of the microwave is shortened. As a result of this, the distribution of standing waves caused by the microwaves within the heating chamber 11 becomes fine, so that there can be obtained the effect of uniformly heating the object to be heated. Also, the shortened wavelength of the microwave decreases the penetration depth of the microwave into the object to be heated, whereby the surface of the object to be heated can be heated particularly.

Next, with respect to the thawing of a frozen food which has been conventionally difficult to heat properly for good cooked state, description will be given below of how to improve the heating conditions of the frozen food by changing the state of the microwave in the interior of the heating chamber 11 in such a manner as described above.

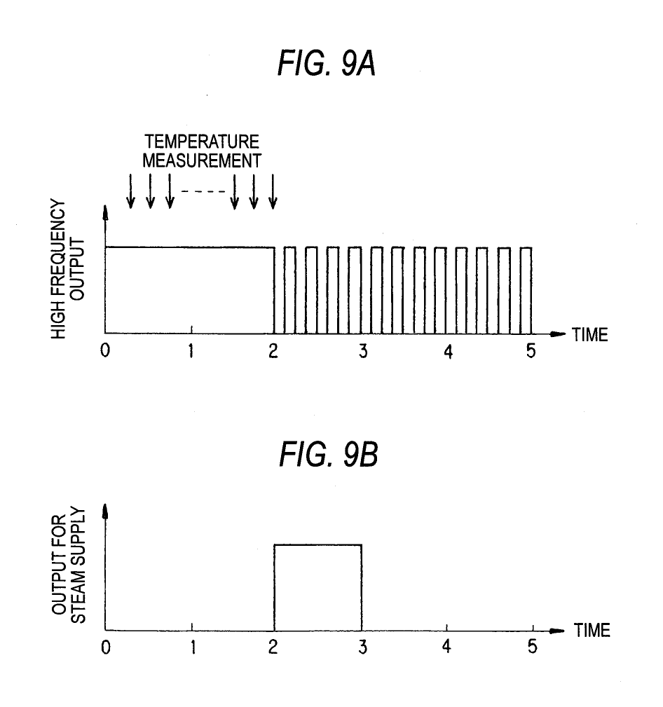

FIG. 9 is a graphical representation of an example of the sequence of microwave heating and steam supply in the thawing processing of a frozen food.

To thaw a frozen food, as shown in FIG. 9A, firstly, the output of microwaves generated from the microwave generating portion 12 is turned on continuously for the first given time (for example, two minutes). At the then time, the temperature distribution of the interior of the heating chamber 11 is also measured using the infrared sensor 18.

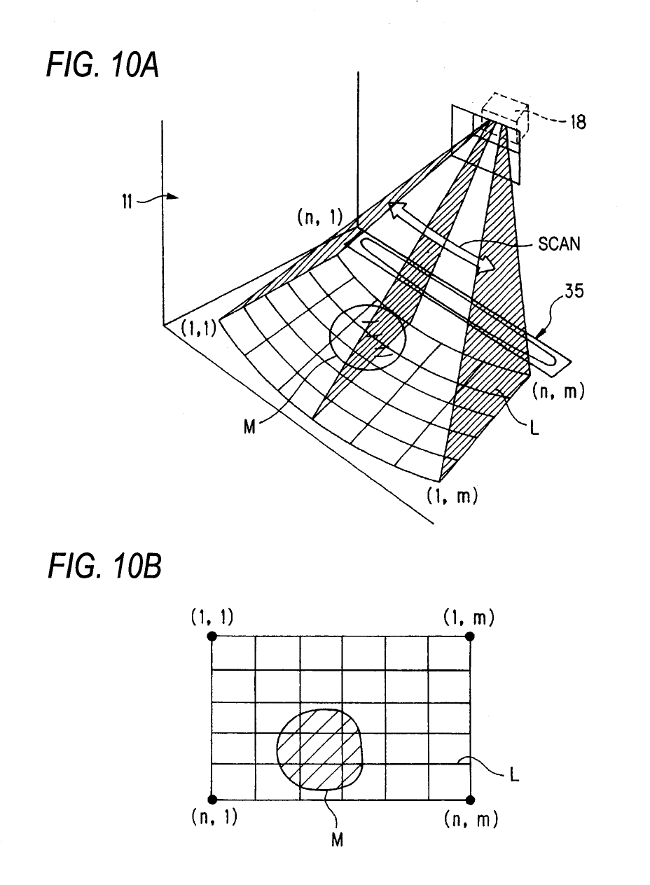

Here, description will be given below of the measurements of the temperatures of the object to be heated using the infrared sensor 18 with reference to FIG. 10.

As shown in FIG. 10A, while the infrared sensor 18 is detecting the temperatures of two or more points (n points) simultaneously, the infrared sensor 18 itself is oscillated, whereby the infrared sensor 18 scans the interior of the heating chamber 11 in the arrow mark direction in FIG. 10A and measures the temperatures of two or more measuring points (m points in the scanning direction) of the interior of the heating chamber 11. Therefore, the scanning operation of the infrared sensor 18 detects the temperatures of all measuring points, that is, n×m points shown in FIG. 10B. Referring to the temperature of the object to be heated M, the placement position of the object to be heated M is found based on the rising rates of the temperatures of the respective measuring points continuously detected with respect to the passage of time, and the thus detected temperature at the placement position is regarded as the temperature of the object to be heated M.

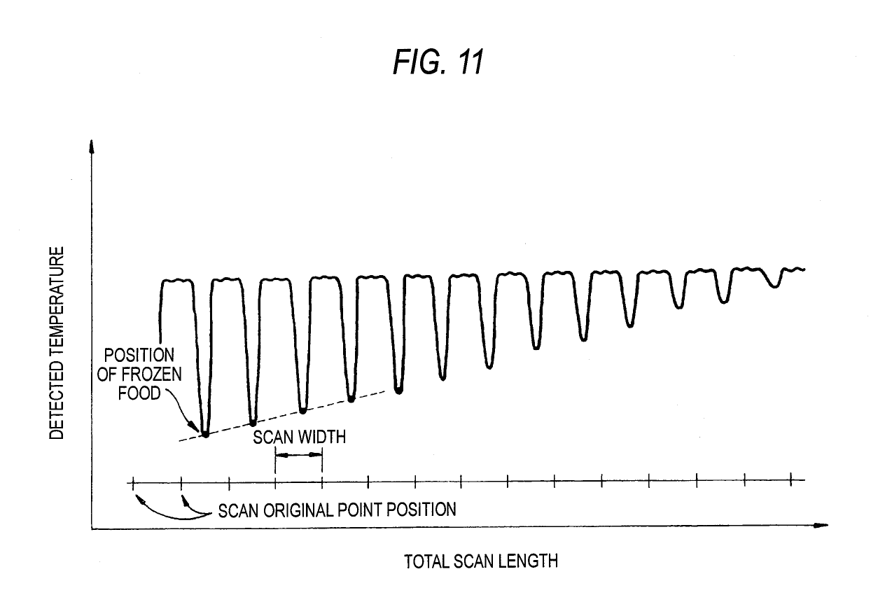

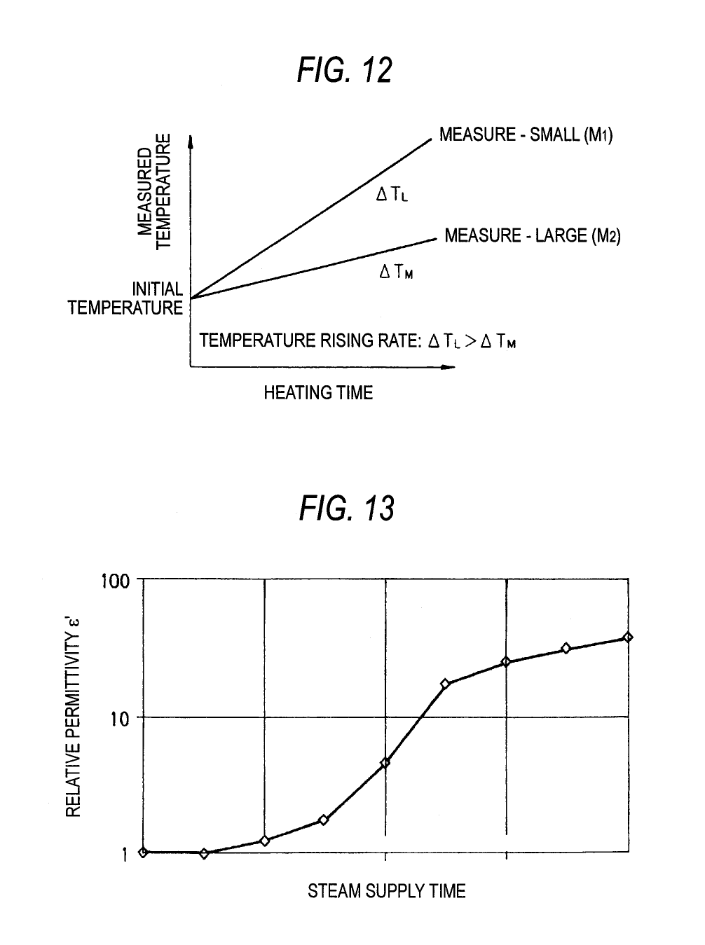

FIG. 11 shows the temperature distribution at the L line position shown in FIG. 10B when the scanning operations by the infrared sensor 18 are carried out two or more times successively. In FIG. 11, the peak position (trough position) of the temperature distribution, in which the temperature varies specifically within one scan width, corresponds to the position of the object to be heated M on the L line in FIG. 10B. Therefore, the position of the object to be heated M within the heating chamber 11 can be found from the peak existing position of the temperature distribution. Here, when the temperature corresponding to the position of the object to be heated M is found while going back to the initial heating time or to the temperature measurement start time, the initial temperature of the object to be heated M can bejudged. Also, by finding the temperature rising rate Δt of the object to be heated M from the slope of a line (a dotted line shown in FIG. 11) connecting together the peaks of a temperature distribution curve shown in FIG. 11, the measure of the object to be heated M can be estimated. The reason for this is as follows: that is, as shown in FIG. 12, when two objects to be heated M1 and M2 different in weight are heated at the same initial temperature under the same condition, the temperature rising rates Δt of the objects to be heated M1 and M2 differ from each other according to the weights thereof, and, when the object to be heated M1 having small measure is heated, the temperature rising rate thereof provides ΔTL and, when the object to be heated M2 having large measure is heated, the temperature rising rate thereof provides ΔTM smaller than ΔTL. Accordingly, by estimating the measure of the object to be heated M from the above-mentioned judgment of the initial temperature of the object to be heated M and temperature rising rate ΔT, the thawing processing end time of the frozen food can be set.

Returning back again to FIG. 9, when the temperature of the object to be heated is increased up to a given temperature due to the microwave heating, as shown in FIG. 9B, steam is supplied from the steam supply portion 15 into the heating chamber 11 for given period of time (here, one minute). With supply of the steam, the relative permittivity (the real number portion of the permittivity) of the interior of the heating chamber 11 increases gradually as shown in FIG. 13, whereby the distribution of the electric fields within the heating chamber 11 is caused to vary. And, as the relative permittivity increases, the wavelength of the microwave decreases, with the result that the first state shown in FIG. 8A is transformed into the second state shown in FIG. 8B and thus, as shown in FIGS. 7B, 7C and 7D, the mode of the high-intensity electric fields turns into a fine distribution mode. By the way, the microwave heating after supply of the steam is controlled intermittently according to a proper duty factor.

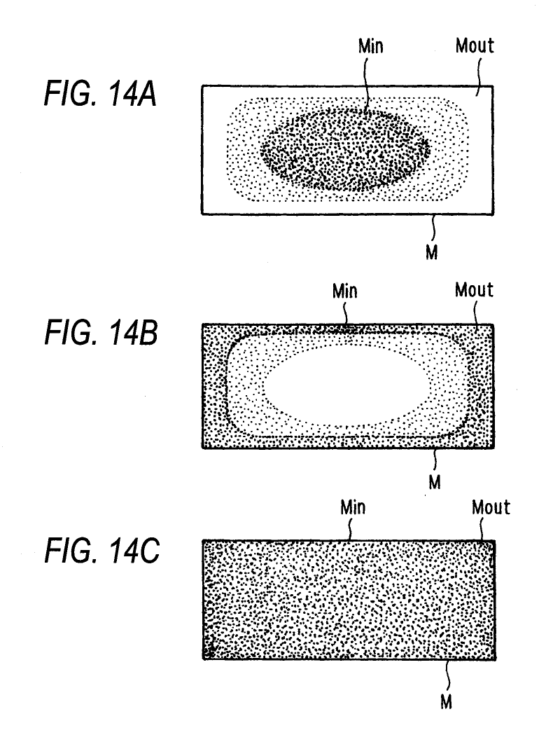

Thus, as can be seen in FIG. 14 which conceptually shows the heating condition of the object to be heated, in the initial stage of the microwave heating, the interior Min of the object to be heated is heated especially strongly as shown in FIG. 14A; after then, by supplying the steam to the heating chamber, the mode is turned into a mode in which high-intensity electric fields are distributed finely, and thus, as shown in FIG. 14B, the surface Mout of the object to be heated is heated especially strongly; and, finally, as shown in FIG. 14C, the cooking of the object to be heated is finished in such a manner that the interior Min and surface Mout thereof are heated uniformly.

And, when the time of the microwave heating reaches the thawing processing end time previously obtained from the weight of the object to be heated, the output of the microwave heating is caused to stop.

In this manner, according to the sequence of the microwave heating and steam supply in the thawing processing of a frozen food, in a first state where, of high- and low-intensity electric fields (antinodes and nodes) obtained by supplying microwaves to the heating chamber 11, two or more high-intensity electric fields (antinodes) are present within the heating chamber 11, the object to be heated is heated using microwaves; and, after then, the water minute particles are supplied from the steam supply part 15 into the heating chamber 11 to thereby change the permittivity distribution state of the interior of the heating chamber 11 into a second state where the number of high-intensity electric fields (antinodes) is increased over the first state, and, in this second state, the object to be heated is heated using microwaves. That is, the object to be heated is microwave heated in two different states. This can restrain the local microwave heating from having an influence on the finally cooked condition of the object to be heated, thereby being able to finish the object to be heated in a good condition with no uneven heating.

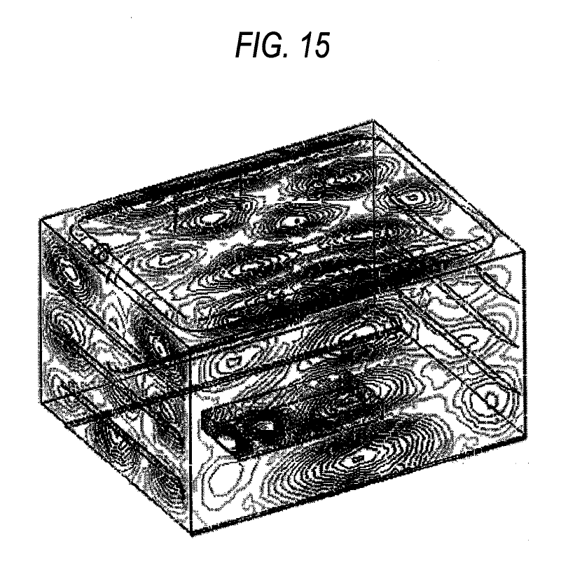

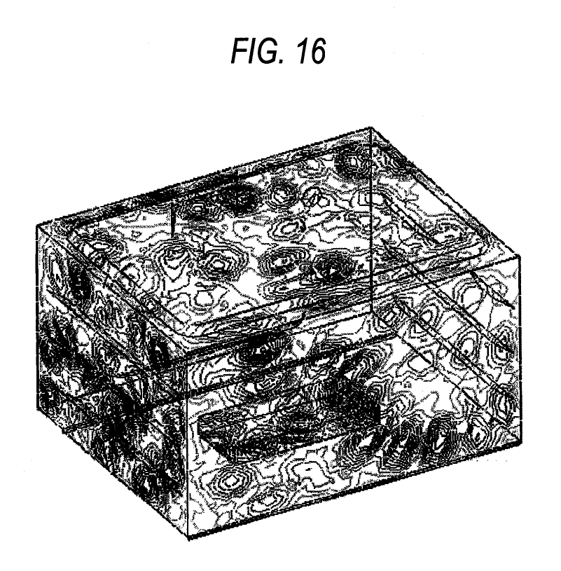

Here, in order to prove the above-mentioned phenomena of the variations of the high-intensity electric fields, the field intensity distribution within a microwave space has been CAE analyzed. From the CAE analysis, there are obtained such equi-intensity electric field diagrams as shown in FIGS. 15 and 16. FIG. 15 shows a case in which the permittivity of the interior of the heating chamber is set for 1 equivalent to the air, while FIG. 16 shows a case in which the permittivity of the whole of the heating chamber is set for 3 equivalent to steam. When these two cases are compared with each other, as a whole, the distributions of high-intensity electric fields are obviously different. Specifically, in FIG. 15, high-intensity electric fields relatively large in size are dotted, whereas, in FIG. 16, high-intensity electric fields are scattered finely. Therefore, by supplying the steam into the heating chamber 11, the number of major heating points (positions where high-intensity electric fields are generated) for microwave heating the object to be heated can be increased, which can control the local heating and thus can finish the cooking of the object to be heated with no uneven temperature.

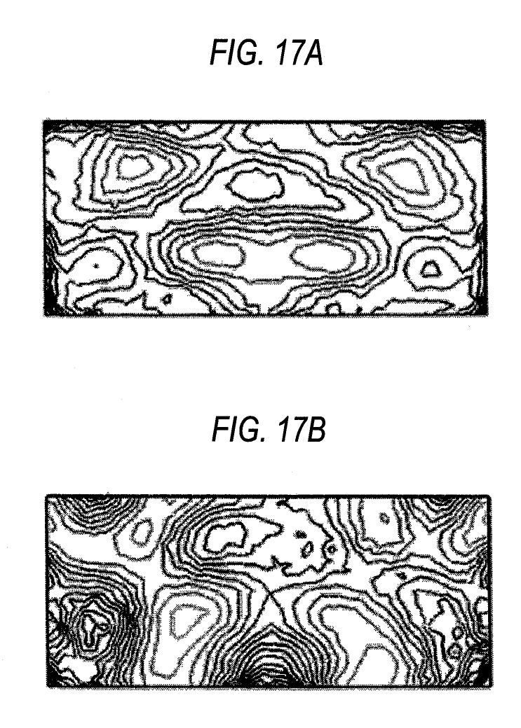

Also, FIG. 17 is a diagram of the equal electric field intensity of the interior of the object to be heated obtained by a CAE analysis. Specifically, FIG. 17A shows a case in which the permittivity of the interior of the heating chamber is set for 1 equivalent to the air, while FIG. 17B shows a case in which the permittivity of the whole of the heating chamber is set for 3 equivalent to the steam. As shown in these figures, depending on whether the steam is supplied or not, in the interior of the object to be heated as well, the distributions of high-intensity electric fields are obviously different. Specifically, the distribution of high-intensity electric fields in the case shown in FIG. 17B where the object to be heated is heated by the microwave heating with supply of the steam is finer than that of the case shown in FIG. 17A where the object to be heated is heated only by the microwave heating without supply of the steam.

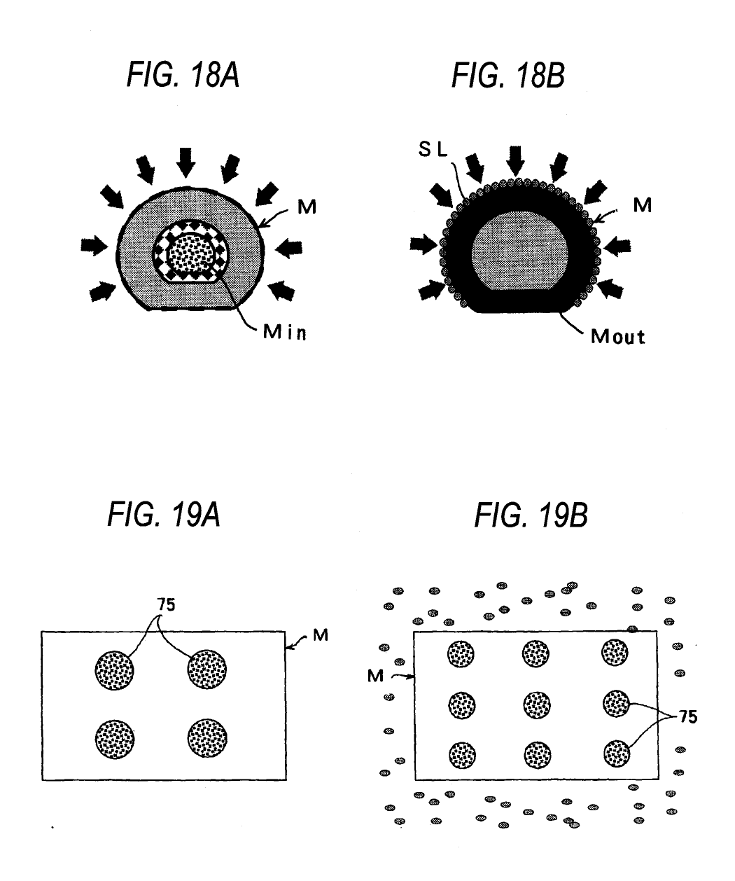

In other words, centering on the object to be heated, in the start of heating by microwaves without supply of the steam, as shown in FIG. 18A, the microwaves penetrate into the interior Min of the object to be heated and thus the object to be heated is heated from the interior thereof, and, after then, with supply of the steam, dew condensation SL forms on the surface of the object to be heated, and the heating energy of the microwaves centers on the dew-condensation water, so that, as shown in FIG. 18B, the heating starts from the outside of the object to be heated. A so called [uniform heating effect of the object to be heated by the steam heating] as shown in FIG. 18B is obtained by making use of the generation of heating from the outside of the object to be heated. On the other hand, the object of the invention to supply steam into the heating chamber is, as shown in FIG. 19 which is modeled on high-intensity electric fields within the object to be heated, to make finer the distribution of high-intensity electric fields shown in FIG. 19B where the object to be heated is heated by microwaves with supply of steam than the distribution of high-intensity electric fields shown in FIG. 19A where the object to be heated is heated simply by microwaves. Owing to the subdivision of the high-intensity electric fields, the heating points (positions of generation of the high-intensity electric fields) are scattered and thus the temperature of the object to be heated is allowed to rise uniformly. After the heating advances further and dew condensation forms on the surface of the object to be heated, the subdivision effect cooperates together with the above-mentioned uniform heating effect due to supply of steam in realizing the further uniform heating of the object to be heated.

In the present embodiment, the steam supply part 15 supplies the water minute particles, which are dielectric substances, into the heat chamber 11 arbitrarily to change the permittivity of the interior of the heating chamber 11. Actually, supply of water into the evaporation dish 35 can also change the permittivity of the interior of the heating chamber 11. Thus, the change of the distribution of high-intensity electric fields starts before generation of the steam, that is, at the time when the water is supplied to the evaporation dish 35, which makes it possible to execute the switching of the distribution of high-intensity electric fields quickly.

Also, when the steam generated is allowed to stand naturally in the upper portion of the heating chamber 11, formation of dew condensation on the object to be heated placed on the bottom surface of the heating chamber 11 can be prevented. Therefore, also in the case of an object to be heated (requiring thawing) for which formation of dew condensation is not desirable, by controlling the supply of steam, the distribution of high-intensity electric fields can be changed to thereby be able to facilitate the uniform heating of the object to be heated.

In other words, by supplying steam into a virtual microwave space to which microwaves are supplied, the permittivity of the interior of the space is increased to thereby be able to seemingly increase the shape of the whole of the microwave space over the actual heating chamber 11. This action can change the distribution of the high-intensity electric fields of microwaves, with the result that the distribution of the high-intensity electric fields within the heating chamber 11 can be changed according to the presence or absence of steam to thereby be able to facilitate the uniform heating of the object to be heated.

Next, description will be given below of a modification of a microwave heating method according to the invention.

In a microwave heating method according to the present modification, when changing the high-intensity electric fields of microwaves within the heating chamber 11, the mode of high-intensity electric fields is arranged in such a manner that, in the above-mentioned first state before supply of steam and second state after supply of steam, the high-intensity electric fields are allowed to occur at mutually different positions as much as possible.

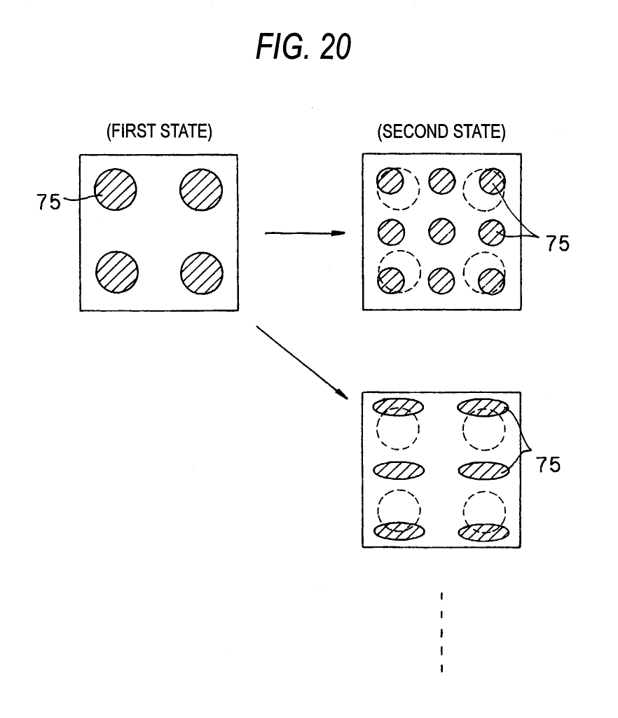

Now, FIG. 20 is an explanatory view of the positions of the high-intensity electric fields in the first and second states. As shown in FIG. 20, for example, for a mode, r=2, s=2 (that is, a mode in which any two of r, s and t are 2) in the first state, in the second state, the high-intensity electric fields are generated so as to contain positions to be complemented in order that the high-intensity electric fields 75 can be generated at positions where the high-intensity electric fields 75 have not been generated in the first state.

To generate the high-intensity electric fields 75 at the positions to be complemented in the second state, the amount of steam to be supplied into the heating chamber 11 may be adjusted to thereby set the permittivity of the interior of the heating chamber 11 that can produce a desired mode, or the direction of the stirrer blade 33 may be changed.

This position control of the high-intensity electric fields makes it possible to microwave heat the object to be heated further uniformly, resulting in the further better result after heated.

Next, description will be given below of a second embodiment of a microwave heating apparatus according to the invention.

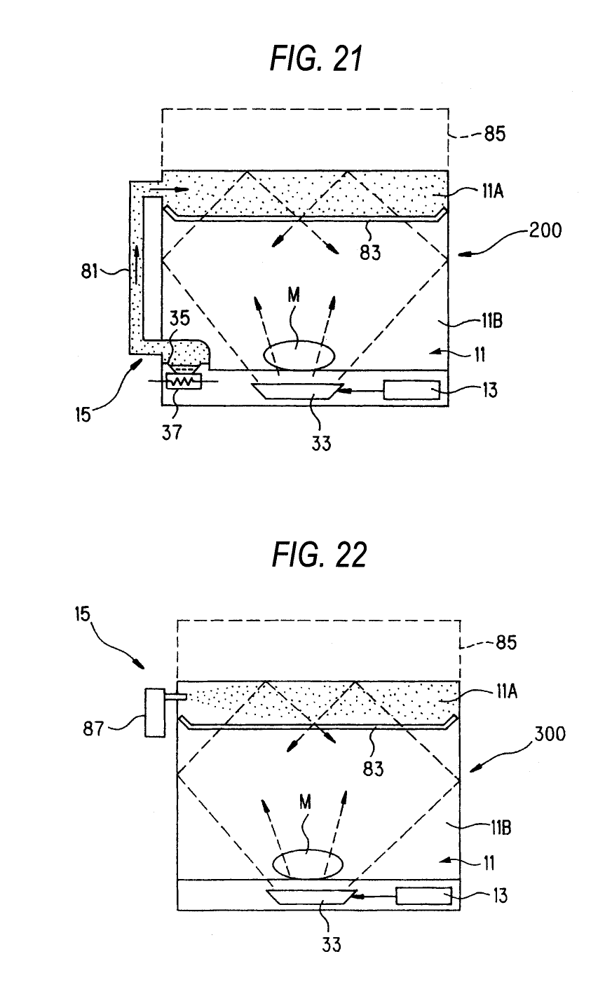

FIG. 21 shows a schematic structure view of a microwave heating apparatus according to the second embodiment of the invention.

In a microwave heating apparatus 200 according to the present embodiment, the steam supply part 15 is structured such that it guides steam generated in the evaporation dish 35 out of the heating chamber 11 once and blows the steam from above the heating chamber 11 through an external pipe 81 into the heating chamber 11 again. Also, on the heating chamber 11, there is mounted a tray 83 made of ceramics, resin, glass or the like which transmits microwaves, while a space within the heating chamber 11 is vertically divided by the tray 83 into upper and lower section spaces.

According to this structure, steam is supplied to the upper section space 11A of the heating chamber 11, so that only the upper section space 11A is filled with the steam. Owing to this, in the case of a microwave to be radiated from the magnetron 13, the higher the permittivity of a place where the microwave is supplied is, the shorter the wavelength of the microwave is; and thus, the microwave acts, as it were, in such a manner that a space where the microwave is supplied is changed in shape. In other words, a virtual microwave space 85 (here, this expression is used to distinguish this space from an actual space within the heating chamber 11) can be seemingly increased in size, and thus the distribution of high-intensity electric fields can also be changed. This can change the effect of heating onto the object to be heated, thereby being able to facilitate the uniform heating of the object to be heated.

By the way, the steam generating means is not limited to a power heating type of steam generating means for heating the evaporation dish 35 including a structure according to the first embodiment but, for example, there may also be used a boiler type of steam generating means. However, when the influence of impurities contained in water and the maintenance of the structure are taken into account, preferably, there may be used a structure in which the evaporation dish 35 is disposed within the heating chamber 11 in an exposed manner. With use of this structure, it is easy to remove scales which stick to the evaporation dish 35 when steam is generated; and, therefore, this structure is excellently sanitary. Also, there may also be employed a drop type structure in which a valve of a water supply passage is opened to drop water drops down to a heating member to thereby generate steam. In this case as well, there can be obtained a similar effect to the case of the evaporation dish 35.

And, by combining together different types of steam generating means, the distribution of electric fields can be changed. For example, a first permittivity distribution state in which, after water is supplied to the evaporation dish 35, the evaporation dish 35 is heated to thereby generate steam and a second permittivity distribution state in which, after the evaporation dish 35 is heated, water is supplied to the evaporation dish 35 to thereby generate steam immediately may be generated independently or simultaneously, with the result that the electric field distribution can be changed.

Next, description will be given below of a third embodiment of a microwave heating apparatus according to the invention.

FIG. 22 shows a schematic structure view of a microwave heating apparatus according to the third embodiment of the invention.

In a microwave heating apparatus 300 according to the present embodiment, the steam supply part 15 is structured such that, instead of use of steam obtained by heating water, it includes mist supply means 87 for supplying mist-like water drops into the heating chamber 11. According to this structure, mist-like water drops of a minute size (mists) are supplied into the heating chamber 11. It is considered that the larger the size of the mist is, the greater the effect of changing the electric field distribution of a microwave is. Therefore, the size of the mist may be set larger than the ordinary size of the mist, 3 μm, preferably, it may be set for 10 μm or larger, more preferably, in the range of 25 μm-100 μm, with the result that the sufficient action of the mist on the microwave can be secured, thereby being able to cause the electric field distribution to change positively.

As the mist supply means 87, generally, there is often used an ultrasonic vibrator of 1.6-2.4 MHz. In order to increase the mist size, there can be used an ultrasonic spray including an ultrasonic vibrator which can be vibrated at 20 kHz-100 kHz; and also, there can be used, for example, a high pressure spray and a spray of a centrifugal type or other types. Also, according to the present embodiment, in view of the fact that, when the mist sticks to the object to be heated, the object to be heated is influenced by impurities or the like contained in water, similarly to the second embodiment, the heating chamber 11 is vertically divided into upper and lower section spaces by the tray 83, and the mist is supplied only to the upper section space 11A.

According to the above structure, the mists are supplied to the upper section space 11A of the heating chamber 11 and only the upper section space 11A is filled with the mists. Therefore, similarly to the second embodiment, the microwave acts in such a manner that a space where the microwave is supplied is changed in shape, which makes it possible to change the distribution of high-intensity electric fields. This can change the effect of heating onto the object to be heated, thereby being able to facilitate the uniform heating of the object to be heated.

Although description has been given heretofore in detail of the invention while referring to the specific embodiments of the invention, it is obvious to those skilled in the art that there are also possible various changes and modifications without departing from the spirit and scope of the invention.

The present application is based on the Japanese patent application No. 2004-132648 filed on April 28 and the contents thereof are incorporated hereinto for reference.

1. A microwave heating method for heating an object to be heated by supplying microwaves into a heating chamber storing therein the object to be heated, comprising the steps of:
supplying microwaves into the heating chamber to heat the object to be heated;
measuring the temperature of the object to be heated to detect whether a given temperature difference has been generated in the temperature distribution of the object to be heated; and,
supplying the minute particles of water into the heating chamber, when the given temperature difference has been generated, to change the permittivity distribution condition within the heating chamber, thereby changing the distribution of an electric field caused by the microwaves supplied into the heating chamber.

2. A microwave heating method as set forth in claim 1, further including the step of finely changing the electric field distribution caused by the microwaves.

3. A microwave heating method as set forth in claim 1, wherein the minute particles of water are composed of steam supplied into the heating chamber.

4. A microwave heating method as set forth in claim 1, wherein the minute particles of water are composed of mist-like water drops supplied into the heating chamber.

5. A microwave heating method for heating an object to be heated by supplying microwaves into a heating chamber storing therein the object to be heated, comprising the steps of:
first heating the object using microwaves in a first state in that, of high- and low-intensity electric fields (antinodes and nodes) provided by supplying microwaves into the heating chamber, portions of the high-intensity electric fields (antinodes) are present two or more in number within the heating chamber; and,
after then, second heating the object using microwaves in a second state in that, the minute particles of water are supplied into the heating chamber to change the permittivity distribution state of the interior of the heating chamber to thereby increase the number of portions of the high-intensity electric fields(antinodes) over the first state.

6. A microwave heating method as set forth in claim 5, wherein the switching from the first state to the second state is executed when the temperature of the object to be heated is measured and a given temperature difference is generated in the temperature distribution of the object to be heated.

7. A microwave heating apparatus for heating an object to be heated by supplying microwaves into a heating chamber storing therein the object, comprising:
a microwave generating part for supplying microwaves to the heating chamber;
temperature measuring means for measuring the temperature distribution of the interior of the heating chamber;
permittivity changing means, by supplying the minute particles of water into the heating chamber, for changing the permittivity distribution state of the interior of the heating chamber; and,
heating control means for controlling the permittivity changing means based on a microwave heating method as set forth in claim 1.

8. A microwave heating apparatus as set forth in claim 7, wherein the permittivity changing means includes a water tank, an evaporation dish disposed within the heating chamber, a water pump for supplying a given amount of water from the water tank to the evaporation dish, and evaporation dish heating means for heating the evaporation dish to generate steam from the evaporation dish.

9. A microwave heating apparatus as set forth in claim 7, wherein the permittivity changing means includes mist supply means for supplying mist-like water drops into the heating chamber.

10. A microwave heating apparatus for heating an object to be heated by supplying microwaves into a heating chamber storing therein the object, comprising:
a microwave generating part for supplying microwaves to the heating chamber;
a water tank;
an evaporation dish disposed within the heating chamber;
water supply means for supplying a given amount of water from the water tank to the evaporation dish;
evaporation dish heating means for heating the evaporation dish to generate steam;
permittivity changing means having a first permittivity distribution state for heating the evaporation dish after supply of the water to the evaporation dish to thereby generate steam and a second permittivity distribution state for supplying the water after the heating of the evaporation dish to thereby generate steam immediately; and,
heating control means for controlling the permittivity changing means.

11. A microwave heating apparatus for heating an object to be heated by supplying microwaves into a heating chamber storing therein the object, comprising:
a microwave generating part for supplying microwaves to the heating chamber;
temperature measuring means for measuring the temperature distribution of the interior of the heating chamber;
permittivity changing means, by supplying the minute particles of water into the heating chamber, for changing the permittivity distribution state of the interior of the heating chamber; and,
heating control means for controlling the permittivity changing means based on a microwave heating method as set forth in claim 5.
